(19) United States
(12) Patent Application Publication
(10) Pub. No.: US 2026/0149188 A1
(43) Pub. Date: May 28, 2026

(54) RADIO FREQUENCY REFLECTOR, ANTENNA SYSTEM, AND METHOD FOR MANUFACTURING A RADIO FREQUENCY REFLECTOR

(71) Applicant: The Boeing Company, Arlington, VA (US)

(72) Inventors: Peter Bablio, Mission Viejo, CA (US); Eric A. Bruton, Lake St. Louis, MO (US)

(73) Assignee: The Boeing Company, Arlington, VA (US)

(21) Appl. No.: 18/956,982

(22) Filed: Nov. 22, 2024

(51) Int. Cl. H01Q 19/19

(52) U.S. Cl. CPC H01Q 19/19

(57) ABSTRACT

A radio frequency (RF) reflector (100) includes a non-metallic substrate (102) shaped to reflect RF energy in a specific direction and a cold-sprayed RF-reflective layer (104) on the non-metallic substrate (102). A method (400) for manufacturing an RF reflector includes providing the non-metallic substrate (402) and cold spraying the RF-reflective layer onto the substrate (406). An antenna system (10) includes an antenna (200) for transmitting and receiving RF energy (300) and a radio frequency reflector (100) positioned to direct RF energy (300) towards or away from the antenna (200).

### FIELD

The present application relates to the field of radio frequency (RF) reflectors, antenna systems, and methods for their manufacture.

### BACKGROUND

Radio frequency (RF) reflectors are widely used in various communication systems, including satellite, radar, and terrestrial applications. These reflectors are designed to reflect and direct RF signals, improving the transmission and reception of electromagnetic waves. The performance of RF reflectors depends heavily on the manufacturing methods employed, particularly with respect to their reflectivity, durability, and thermal management.

A common method for manufacturing RF reflectors involves multi-layer vapor deposition. In this process, alternating layers of materials, such as aluminum and silicon dioxide, are deposited in a vacuum chamber. The aluminum layers are applied to enhance RF signal reflection, while other materials like silicon monoxide (SiO) or silicon dioxide (SiO₂) are used to protect the aluminum from oxidation, improve adhesion, and manage thermal properties by increasing emissivity. Although effective, the multi-layer vapor deposition process requires several complex steps, including the use of vacuum chambers, which increases production time and cost.

Another approach is the use of a single aluminum layer deposited via vapor deposition. In this method, a single reflective layer of aluminum is applied in a vacuum, and then an electrostatic discharge (ESD) white paint is added on top. The white paint serves to manage thermal loads by reflecting solar energy and radiating energy while dissipating electrostatic charges. This single-layer approach is simpler than the multi-layer method, but still requires vacuum deposition, limiting its efficiency in terms of production speed and cost.

Accordingly, those skilled in the art continue with research and development in the field of RF reflectors, antenna systems and methods for manufacturing.

### SUMMARY

Disclosed are radio frequency (RF) reflectors.

In one example, the disclosed radio frequency reflector includes a non-metallic substrate shaped to reflect RF signals in a specific direction and a cold-sprayed RF-reflective layer on the non-metallic substrate.

In another example, the disclosed radio frequency reflector includes an electrically insulating layer positioned between the non-metallic substrate and the cold-sprayed RF-reflective layer, and an electrostatic discharge (ESD) paint layer applied on the cold-sprayed RF-reflective layer.

Also disclosed are methods for manufacturing radio frequency reflectors.

In one example, the disclosed method for manufacturing a radio frequency reflector includes providing a non-metallic substrate shaped to reflect RF energy and cold spraying a radio frequency-reflective layer on the substrate. The method may further include applying an electrically insulating layer positioned between the non-metallic substrate and the cold-sprayed RF-reflective layer and an ESD paint layer over the RF-reflective layer.

Also disclosed are antenna systems.

In one example, the disclosed antenna system includes an antenna for transmitting and receiving RF signals and a radio frequency reflector positioned to direct RF energy towards or away from the antenna, wherein the radio frequency reflector includes a non-metallic substrate and a cold-sprayed RF-reflective layer.

Other examples of the disclosed radio frequency reflectors, antenna systems, and methods for manufacturing will become apparent from the following detailed description, the accompanying drawings and the appended claims.

### BRIEF DESCRIPTION OF THE DRAWINGS

FIG. 1 is a cross-sectional view of a radio frequency reflector, illustrating the non-metallic substrate, the cold-sprayed RF-reflective layer, and an optional electrostatic discharge (ESD) paint layer.

FIG. 2 is a schematic view of an antenna system incorporating a radio frequency reflector, showing the positioning of the reflector in relation to the antenna for directing RF energy.

FIG. 3 is a flow diagram depicting the overall process for manufacturing a radio frequency reflector, including the steps of providing a non-metallic substrate, applying an optional electrically insulating layer, cold spraying the RF-reflective layer, and applying an ESD paint layer.

FIG. 4 is a graph illustrating the optical reflectance properties of the radio frequency reflector across a range of wavelengths, showing high reflectivity and low solar absorptance.

FIG. 5 is a graph depicting the hemispherical directional reflectance of the radio frequency reflector, demonstrating its effectiveness in reflecting RF signals over relevant wavelength ranges.

### DETAILED DESCRIPTION

The following detailed description provides explanations of various examples of the invention. These examples are offered to assist in understanding the principles and practical applications of the invention, but are not intended to limit its scope. Variations, modifications, and adaptations may be made to the examples described without departing from the spirit and scope of the invention.

The described examples include various features and combinations of features. However, not all features are required in every example of the invention, and combinations of the described features may be adapted or adjusted for specific applications. Alternative materials, configurations, and manufacturing techniques may also be used in the practice of the invention, as appropriate to the intended use.

While certain ranges of parameters, dimensions, and materials are described, these are intended as examples and may be adjusted based on specific design requirements. The invention can encompass broader or narrower ranges, as will be appreciated by those skilled in the art.

The present disclosure relates to a radio frequency (RF) reflector designed for use in communication systems, including satellite, radar, and terrestrial applications. RF reflectors are components used to reflect and direct radio frequency energy to improve transmission and reception performance. By managing radio frequency energy, the reflector operates alongside antennas to enhance the overall functionality of the communication system.

The RF reflector described includes multiple layers that contribute to its structural design and performance. These layers include a non-metallic substrate that serves as the foundation and a cold-sprayed RF reflective layer that improves signal reflection. The reflector may also include additional layers, such as an electrically insulating layer and an electrostatic discharge (ESD) layer, which provide further benefits like electrical insulation, thermal control, and electrostatic management.

The following detailed description outlines the structure, composition, and method for manufacturing the RF reflector and an antenna system including the RF reflector.

### RF Reflector

A radio frequency (RF) reflector is used in various RF communication systems, including satellite, radar, and terrestrial applications. Its function is to reflect and direct radio frequency energy, focusing energy in a specific direction to improve the transmission or reception of signals. In an antenna system, the RF reflector works alongside an antenna to enhance overall performance by efficiently managing electromagnetic waves.

The performance of an RF reflector depends on its structural design and material composition. The reflector is designed to minimize signal loss and optimize reflectivity, while also considering thermal and electrostatic management. In environments such as space-based communication, the RF reflector operates under challenging conditions, including high temperatures, vacuum, and potential electrostatic charge buildup. To address these demands, an RF reflector typically includes multiple layers, each providing distinct functional advantages.

The reflector generally includes a non-metallic substrate that provides the base structure, and an RF reflective layer that reflects RF signals. The materials selected for the substrate and the reflective layer influence the reflector's ability to perform under specific conditions. Additional layers, such as electrically insulating layers and electrostatic discharge (ESD) layers, may be incorporated to improve performance by providing thermal control, electrical insulation, and charge dissipation.

### Non-Metallic Substrate

The non-metallic substrate forms the foundational base of the RF reflector and provides structural support for reflecting radio frequency energy. Its material and shape are selected based on performance requirements, including radio frequency energy reflection, mechanical strength, and environmental resilience.

A wide range of materials can be used for the non-metallic substrate, depending on the application. These materials include ceramics, glass, polymers, carbon, or combinations of these materials. Ceramics are often used for their thermal stability and mechanical strength, making them suitable for high-temperature or harsh environments. Glass offers rigidity and thermal properties, while also contributing to the RF performance in certain applications. Polymers provide design flexibility and are often selected for applications where weight reduction is a priority. Carbon materials, such as graphite, provide excellent strength-to-weight ratios and are particularly useful in aerospace and space-based systems where minimizing mass is essential.

In some examples, the substrate is a composite material, such as graphite fibers embedded in a polymer matrix. This configuration combines the lightweight and strength properties of graphite with the flexibility and resilience of polymers. The polymer matrix serves to hold the graphite fibers in place, creating a material with enhanced stiffness, durability, and impact resistance, while maintaining a low overall weight. Such a composite material is often used in demanding environments like spacecraft applications where both strength and weight are critical factors.

The shape of the non-metallic substrate significantly impacts the RF reflector's ability to direct and reflect radio frequency energy, and can be tailored to meet specific design and performance requirements. Substrates may be shaped as planar surfaces for basic RF signal reflection or take more complex forms, such as parabolic, concave, convex, spherical, cylindrical, or hyperbolic shapes, to focus or scatter signals with precision. Additional shapes, including ellipsoidal, pyramidal, and conical, may be employed for targeted signal reflection and focusing, while additional forms like truncated cones, dish-shaped reflectors, waveguide horn shapes, corner reflectors, and compound curves are used for specific applications. Polygonal, toroidal, and spiral configurations offer further customization options for specific RF signal control. This versatility in shaping allows the RF reflector to be adapted for a wide range of applications, optimizing its ability to focus, direct, or scatter RF signals based on system requirements.

### Electrically Insulating Layer

An electrically insulating layer may optionally be positioned between the non-metallic substrate and the cold-sprayed RF reflective layer. Its primary function is to provide electrical insulation, preventing interference between the substrate and the reflective layer. In some configurations, the non-metallic substrate may be selected to perform this insulating function, in which case the electrically insulating layer may not be present.

To perform effectively, the electrically insulating layer should withstand the cold spray process, where particles are deposited at high velocity. This process subjects the underlying layers to mechanical stress, so the electrically insulating layer should exhibit sufficient mechanical strength and adhesion to remain intact during deposition. The material should also demonstrate good thermal stability, particularly if the cold spray process occurs at elevated temperatures. Epoxy-based polymers are commonly used for their strong adhesive properties and durability, while polyimides and other high-performance polymers can offer stability in higher-temperature environments.

The selection of materials for the electrically insulating layer depends on their ability to withstand these conditions, while providing effective insulation. Suitable materials include a variety of polymers that offer a balance of strength, flexibility, and thermal performance. Examples include epoxies for their adhesive properties and mechanical strength, polyimides for maintaining structural integrity at high temperatures, polyetheretherketone (PEEK) for its excellent mechanical and thermal properties, polypropylene (PP) for its lightweight and chemical resistance, polytetrafluoroethylene (PTFE) for electrical insulation and heat resistance, polyethylene (PE) for its chemical resistance, polyurethane for flexibility and abrasion resistance, acrylic-based polymers for weather and heat resistance, and nylon (polyamide) for its strength and durability.

In some cases, the electrically insulating layer may incorporate non-electrically conducting fillers to enhance its mechanical properties or thermal stability. Examples of such fillers include silica (SiO2), alumina (Al2O3), zirconia (ZrO2), glass fibers, mica, talc, calcium carbonate, boron nitride, and kaolin clay. These fillers can improve the layer's strength, wear resistance, or thermal performance without affecting its insulating capabilities.

### Cold-Sprayed Radio Frequency Reflective Layer

The cold-sprayed radio frequency reflective layer forms the surface responsible for reflecting radio frequency energy. The cold-sprayed radio frequency reflective layer has a distinct structure formed by the cold spray process, which sets it apart from other RF reflective coatings. The cold-sprayed layer typically comprises metallic materials, which are selected for their high conductivity and reflectivity of radio frequency energy.

The cold spray process involves the spraying of metallic particles at high velocity, creating a mechanically bonded layer through the deformation of the particles upon impact. The structure resulting from this cold spray process is distinct in its characteristics compared to vapor-deposited layers, which typically form as continuous films.

The materials used in the cold-sprayed radio frequency reflective layer can vary depending on the specific application and performance requirements. Suitable materials include aluminum, known for its lightweight properties and high conductivity, and copper, which provides excellent electrical conductivity for RF reflection. Other metals that may be used include silver, gold, zinc, magnesium, nickel, and platinum, either individually or in combinations. These materials may be selected based on their ability to enhance reflectivity, provide environmental resistance, or offer high electrical conductivity. In some applications, aluminum alloys are chosen for their ability to provide additional strength while maintaining low weight.

The structure of the cold-sprayed radio frequency reflective layer may be characterized by a grain formation resulting from the cold spray process. The layer is formed by a plurality of grains, each of which is mechanically bonded to adjacent cold-sprayed grains during the high-velocity deposition process. This grain structure distinguishes the cold-sprayed RF reflective layer from other types of reflective layers, such as those produced through vapor deposition, where the layer forms as a continuous film. The mechanical bonding between these grains contributes to the stability of the layer, ensuring that the material remains securely attached to both the substrate and neighboring grains, even under challenging environmental conditions.

The cold-sprayed RF reflective layer exhibits a controlled level of porosity, a characteristic of the cold spray process. Unlike vapor-deposited film layers, which have zero porosity, the cold-sprayed layer contains micro-pores formed by the high-velocity impact of metal particles. The porosity level in the cold-sprayed layer generally ranges from about 0.1% to about 10%, distinguishing it structurally from vapor-deposited layers. In certain embodiments, the porosity may range from about 0.1% to about 2%, while in other embodiments, it may range from about 2% to about 5%. In still other embodiments, the porosity may range from about 5% to about 10%. This inherent porosity, which can be adjusted by controlling process parameters, is a distinguishing feature of the cold-sprayed RF reflective layer. Additionally, the porosity can provide an advantage for adhesion of subsequent layers, such as the electrostatic discharge (ESD) coating. The micro-pores can create a textured surface that facilitates mechanical interlocking, thereby enhancing the adhesion and durability of the ESD coating layer.

The relative density of the cold-sprayed RF reflective layer is another characteristic that differentiates it from vapor-deposited film layers. Vapor-deposited layers typically have a relative density of 100%, while the cold-sprayed layer, formed by mechanical interlocking of metal particles, does not achieve full density. The relative density of the cold-sprayed layer generally ranges from about 90% to about 99%. In certain embodiments, the relative density may range from about 90% to about 93%, in other embodiments from about 93% to about 96%, and in further embodiments from about 96% to about 99%. This variation in density, depending on the process parameters, serves as a distinguishing characteristic of the cold-sprayed RF reflective layer.

The thickness of the cold-sprayed radio frequency reflective layer can be tailored based on the specific requirements of the application. The thickness can range from 1 micron to 1000 microns, depending on the amount of material deposited. In some cases, the layer may have a thickness between 5 microns and 200 microns, or in other cases, a more controlled range between 15 microns and 75 microns. The thickness can be adjusted depending on various performance or design considerations.

### Electrostatic Discharge (ESD) Paint Layer

An electrostatic discharge (ESD) paint layer may be applied over the cold-sprayed RF reflective layer to prevent the accumulation of static charge that could otherwise arise if a non-ESD paint layer were used. While the cold-sprayed RF reflective layer itself does not inherently accumulate charge due to its conductive properties, applying a non-ESD paint layer would insulate the surface, leading to potential static charge buildup. The ESD paint layer resolves this issue by dissipating electrostatic charges, thereby enhancing the reliability of the underlying and adjacent electronic systems and preventing potential damage or interference from electrostatic discharge.

In some embodiments, the ESD paint layer may be formulated as an ESD white paint layer, which offers additional benefits, such as high solar reflectance (e.g., solar absorptance of less than 0.30), making it particularly useful for applications where thermal management is important, such as space or outdoor environments. In certain embodiments, the solar absorptance of the ESD white paint layer may be less than 0.20 (intermediate range), and in preferred embodiments, the solar absorptance may be less than 0.12. White coatings minimize solar absorptance, allowing the system to maintain lower surface temperatures by reflecting solar radiation. In other applications where solar reflectance is less critical, the ESD paint layer may be formulated with a darker color, resulting in higher solar absorptance (e.g., greater than 0.30).

The ESD paint layer typically incorporates conductive or semi-conductive pigments to achieve its primary function of charge dissipation, while maintaining the white color for solar reflectance. For white ESD paint, suitable pigments include metal oxides, such as zinc oxide and indium tin oxide (ITO), which offer conductivity while preserving the white appearance. In some embodiments, other ceramic particles or metal-doped oxides may be used, as these materials help achieve the desired balance of conductivity and high solar reflectance. Conductive polymers that are color-neutral, or carbon-based materials like graphene, may also be used in formulations designed to maintain the white color, while still providing effective charge dissipation. These conductive pigments are held together by a binder, which ensures adhesion to the cold-sprayed RF reflective layer. For white ESD paint, particularly in space or outdoor applications, white silicone binders are commonly used, as they provide both thermal stability and durability while maintaining high solar reflectance. The binder may also comprise other materials, such as organic polymers, silicate-based binders, inorganic binders, or resins, depending on the desired characteristics of the coating, such as flexibility and environmental resistance. Inert fillers, such as barium sulfate or silica, which are commonly used in white paints, may be included to further enhance the mechanical properties, improve solar reflectance, and reduce costs. In other embodiments, where solar reflectance is less critical, the ESD paint layer may be formulated with non-white pigments, such as metals like silver, copper, zinc, aluminum, and nickel, or carbon-based pigments like carbon black, to tailor the conductivity and appearance of the paint for specific performance requirements.

The surface resistivity of the ESD paint layer may be designed to fall within the range of 10⁵ to 10¹² ohms per square, ensuring that the layer efficiently dissipates electrostatic charges without compromising other functionalities. In addition to its electrical conductivity, the ESD paint layer can be formulated to offer thermal control properties. In environments where temperature regulation is important, the coating can provide low solar absorptance while maintaining high emittance, thereby assisting in thermal management.

The thickness of the ESD paint layer is customizable based on performance requirements. Thicker layers may be used to enhance durability and improve thermal management, while thinner layers may be preferred in applications requiring minimal weight, improved adhesion, or greater flexibility. Additionally, the ESD paint can be tailored to offer other benefits, such as corrosion resistance or increased mechanical protection, depending on the environment in which the system operates.

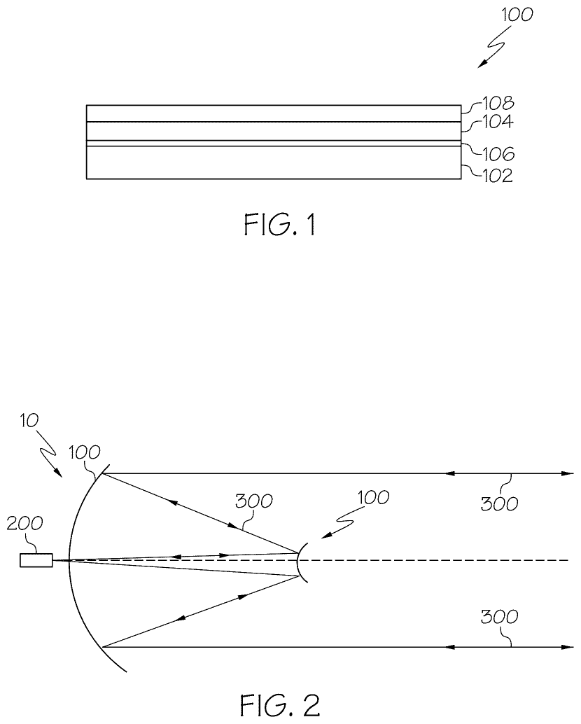

### Example of FIG. 1

FIG. 1 illustrates an example of the RF reflector (100) in accordance with the present invention. This example highlights how the different structural layers are arranged to achieve the desired RF reflection, thermal control, and electrostatic performance.

The RF reflector (100) includes:

Non-metallic substrate (102): This forms the foundational base of the RF reflector. In this example, the substrate may be made from a lightweight carbon composite material, which is selected for its balance of thermal stability and mechanical strength. The substrate may be shaped to optimize the reflection of RF signals, with geometries that could include parabolic, planar, or compound curves based on the specific application.

Cold-sprayed RF reflective layer (104): Applied onto the non-metallic substrate (102), the cold sprayed RF reflective layer may be metal layer formed through a cold spray process, which results in a mechanically bonded structure composed of grains of metal, such as aluminum or copper. The distinct grain boundaries, created by the cold spray process, give this layer a distinct structure compared to more traditional RF reflective coatings. In this example, the cold-sprayed layer provides the primary surface responsible for reflecting RF signals in the antenna system.

Electrically insulating layer (106) (optional): Positioned between the non-metallic substrate (102) and the RF reflective layer (104), this optional layer serves to provide electrical insulation, preventing unwanted interference between the substrate and the reflective layer. The insulating layer is made from polymers that can withstand the cold spray process while maintaining their non-conductive properties. In some embodiments, the electrically insulating layer (106) is absent, allowing the RF reflective layer (104) to be applied directly to the substrate (102).

ESD white paint layer (108) (optional): This outermost layer is applied as a top coat to enhance thermal control and provide electrostatic discharge (ESD) protection. The paint is designed to reflect solar radiation, reducing thermal loading on the reflector, while also dissipating electrostatic charges that may accumulate on the surface. The layer may be composed of silicone-based or silicate-based paint with pigments that exhibit low solar absorptance and high emissivity.

### Overview of the Antenna System

An antenna system is designed to transmit and receive radio frequency (RF) signals, serving as a component in communication technologies such as satellite systems, aerospace platforms, and ground-based networks. The system includes various components working in coordination to direct RF signals with precision and efficiency. By focusing on the controlled transmission and reception of RF energy, the antenna system enables effective communication over long distances and in diverse environments.

The integration of elements, such as an RF reflector, enhances the system's ability to focus and direct signals, thereby improving overall performance and reliability in communication applications. The RF reflector plays an important role in shaping and directing RF signals. Positioned in relation to the antenna, the reflector helps control the signal path, focusing or dispersing RF energy to meet the system's specific performance needs. This interaction between the RF reflector and the antenna can be designed to optimize signal strength, reduce interference, and improve overall system performance.

### Antenna

An antenna is a component in systems designed to transmit and receive radio frequency (RF) signals, playing an important role in communication technologies such as satellite systems, aerospace platforms, and ground-based networks. In systems utilizing reflectors, such as parabolic or Cassegrain configurations, the antenna often includes a feedhorn, which serves as the primary element for transmitting and collecting RF signals. The feedhorn works in conjunction with RF reflectors to enhance signal directionality and efficiency. The primary function of the antenna, including the feedhorn, is to efficiently send and collect RF signals, allowing communication over long distances, often in challenging environments. Depending on the specific application, the antenna design may vary to suit the system's requirements, incorporating different types of feed systems and reflectors to optimize performance.

### RF Reflector

As described previously, the RF reflector enhances the directionality and efficiency of RF signal transmission and reception in the antenna system. It includes a non-metallic substrate, a cold-sprayed RF reflective layer, and optional layers such as the electrically insulating layer and ESD white paint. The substrate, made from materials like carbon composites, ceramics, or polymers, provides structural support, while the cold-sprayed RF reflective layer, created by high-velocity deposition of metallic particles, enables efficient RF reflection. Optional layers, such as the ESD white paint for thermal control, further enhance performance.

The cold-sprayed RF reflective layer plays an important role in integrating with the antenna to improve the system's signal management. Positioned to direct RF signals efficiently, the layer supports the antenna's function by reflecting RF energy with minimal signal loss or distortion. Its structural characteristics contribute to maintaining reliable signal transmission and reception, important for optimal communication performance in the antenna system.

### Other Components of the Antenna System

An antenna system may include additional components that support the effective transmission and reception of RF signals, enhancing the system's overall functionality and performance. These components work together to ensure that the system operates efficiently in various communication environments, including satellite systems, aerospace platforms, and ground-based networks.

One such component is the feed system, which directs RF signals between the antenna and the transmitter or receiver. In many designs, the feed system includes a waveguide or coaxial cable that carries the RF signals from the transmitter to the antenna for broadcasting, or from the antenna to the receiver for processing. The primary feed may be located at the focal point of a parabolic reflector or positioned in relation to other antenna types to achieve optimal signal directionality. Feed systems can also include horn feeds or microstrip feeds, depending on the antenna design, and may incorporate phase shifters for beam steering. Integration with the RF reflector ensures that the RF signals are precisely guided towards or away from the antenna, reducing signal loss and improving overall performance. In some configurations, multiple feed systems are used to enable multi-band or multi-beam operations, supporting simultaneous transmission or reception of different signals, a feature common in advanced satellite communications systems.

The support structure is another component, providing stability and alignment of the antenna and RF reflector. A typical support structure may include trusses, booms, or frames designed to hold the reflector and antenna in position relative to each other. These structures are designed to withstand environmental factors, such as vibrations, thermal expansion, or mechanical stress encountered during launch or in-flight conditions for aerospace applications. Adjustable support structures may include mechanical or electronic actuators to fine-tune the position and orientation of the reflector and antenna to maintain optimal alignment throughout the system's operation. In certain high-performance applications, the support structure may be constructed from lightweight, high-strength materials like carbon fiber composites or titanium alloys, to ensure minimal interference with RF signals and to meet weight and durability requirements.

Other potential components include beamforming networks, which control the direction and shape of the RF signal beam to enhance focus and reception. Additionally, radomes may be used to protect the antenna system from environmental factors, such as weather or debris, without interfering with RF signal transmission. Power supplies and amplifiers may also be integrated to provide the necessary energy for the antenna and enhance signal strength. Finally, a control system may be included to monitor and adjust the antenna system's performance in real-time, ensuring that the system operates at peak efficiency even in challenging environments.

### Example of FIG. 2

FIG. 2 illustrates an example of the antenna system (10) using a Cassegrain configuration, which includes both an antenna, in particular, a feedhorn (200), and two RF reflectors (100), a concave primary mirror and a convex secondary mirror. In this system, the RF reflectors are responsible for directing and focusing RF signals to and from the feedhorn, enhancing the system's overall efficiency in communication applications such as satellite systems, aerospace platforms, and ground-based networks.

The feedhorn (200) is positioned to transmit and receive RF signals, while the two RF reflectors (100) are arranged to reflect the RF energy. In a typical Cassegrain setup, the larger primary RF reflector focuses the signals onto the secondary RF reflector, which then directs them toward or away from the feedhorn. Both the primary and secondary RF reflectors (100) may incorporate the structure previously described, including a non-metallic substrate, a cold-sprayed RF reflective layer, and optional functional layers such as an electrically insulating layer or ESD white paint.

The RF signals follow defined RF paths (300) between the reflectors and the feedhorn. The placement and design of the RF reflectors ensure efficient reflection of the signals with minimal distortion, thus enhancing the precision and reliability of signal transmission and reception. This arrangement allows the antenna system to support long-distance communication in a variety of challenging environments, while the layered structure of the RF reflectors offers additional thermal and electrostatic protection as needed for specific applications.

It should be noted that the present description is not limited to the particular illustrated Cassegrain arrangement. Other configurations and arrangements of the antenna system and RF reflectors are known and may be employed based on specific application requirements. For example, alternative reflector geometries and arrangements may be used to achieve similar objectives. The specific arrangement of the RF reflectors and the feedhorn (or antenna) can be tailored to meet the performance needs of different communication environments without departing from the scope of this invention.

### Method for Manufacturing a Radio Frequency Reflector

The method for manufacturing a radio frequency (RF) reflector involves multiple steps designed to create a highly efficient and reliable reflector for RF communication systems. The following steps may be adapted to suit specific application requirements, ensuring flexibility in the production process.

### Providing the Non-Metallic Substrate

The first step involves providing a non-metallic substrate, which serves as the foundation of the RF reflector. The substrate may be made of various materials, such as ceramics, glass, polymers, carbon, or combinations thereof. In some cases, the substrate may be made of fiber-reinforced materials, such as carbon or glass fibers embedded in a polymer matrix, providing a balance of strength and thermal stability. In other examples, the substrate may be made from a carbon composite, such as graphite or carbon fiber laminates, which offer excellent structural integrity and are particularly suited for applications requiring both mechanical strength and lightweight properties, such as aerospace and satellite systems. The choice of material depends on the desired performance, such as mechanical strength, RF signal reflection, weight considerations, and environmental resilience.

The substrate may be shaped to reflect radio frequency energy in a specific direction. Possible shapes include planar surfaces, parabolic forms, convex, concave, cylindrical, or other more complex geometries. The specific shape of the substrate can be tailored to the requirements of the RF system, optimizing signal reflection, focusing, or dispersing based on the application.

Typically, the formation of the substrate involves processes such as molding, machining, or additive manufacturing. For example, composite substrates may be formed through lay-up techniques where layers of composite materials are laminated together and cured under heat and pressure. Ceramic or glass substrates may be formed through casting or sintering processes, where the material is shaped and then heated to achieve the desired mechanical properties. In certain cases, substrates made from polymers or carbon materials may be fabricated using injection molding or thermoforming, allowing for precise control over the geometry and structural integrity.

Additionally, the surface of the substrate may be prepared using cleaning and inspection techniques to remove contaminants, ensuring adhesion for the subsequent layers. This preparation may include solvent cleaning, mechanical polishing, or plasma treatment to enhance the surface's adhesion properties. Inspection methods, such as visual inspection or surface analysis, may be used to ensure the substrate is free from defects that could affect the performance of the reflector.

### Cold Spraying the RF Reflective Layer

Once the substrate is prepared, the next step involves cold spraying a radio frequency-reflective layer onto the non-metallic substrate. This layer may include a metal or alloy, such as aluminum, copper, silver, gold, zinc, magnesium, nickel, platinum, or alloys thereof, depending on the desired conductivity, reflectivity, and environmental resistance. Aluminum is commonly used due to its lightweight properties and high conductivity, making it ideal for space-based and aerospace applications.

The cold spray process typically involves the use of a high-velocity particle deposition technique in which metal particles are accelerated through a nozzle at supersonic speeds using a compressed gas, typically nitrogen or helium. These particles impact the substrate at such high velocity that they plastically deform and bond to the surface through mechanical interlocking. This process occurs at relatively low temperatures compared to other coating methods, ensuring that the properties of the substrate are not altered or damaged by excessive heat.

The cold-sprayed layer may be characterized by a distinct grain structure, where individual cold-sprayed grains are mechanically bonded to adjacent grains. This grain structure enhances the stability and adhesion of the layer, creating a mechanically robust and durable RF reflective surface. The process also allows for control over layer thickness, ensuring uniform coverage across complex substrate geometries.

The cold spray process can be performed using robotic systems that control the spray gun movement with precision, ensuring consistent application over large or intricate surfaces. This method is particularly advantageous for RF reflectors with complex shapes, such as parabolic or concave forms, as the robotic system can easily adjust the spray angle to provide uniform coverage even on curved surfaces.

The thickness of the cold-sprayed RF reflective layer may vary based on performance requirements. In general, the thickness may range from about 1 micron to about 1000 microns, with more specific ranges, such as 5 to 200 microns or 15 to 75 microns, being used based on the desired balance between weight, conductivity, and RF performance. The cold spray technique allows for control of the layer thickness, which is important in optimizing the reflector's performance while minimizing weight in aerospace and space applications.

After the cold spraying process, quality control measures such as visual inspection, thickness measurement, and adhesion testing may be performed to ensure that the reflective layer meets the specified requirements.

### Applying the Electrically Insulating Layer (Optional)

In certain examples, an electrically insulating layer may be applied between the non-metallic substrate and the cold-sprayed RF reflective layer. This optional layer serves to prevent electrical interference or signal distortion between the substrate and the reflective layer, which can be important in applications where electrical isolation is necessary for optimal performance. The electrically insulating layer may also help to prevent galvanic corrosion by decoupling the substrate and the RF reflective layer.

The electrically insulating layer may be composed of various polymers, such as epoxies, polyimides, or polyether ether ketone (PEEK), selected for their mechanical resilience and ability to withstand high temperatures during the cold spraying process. These materials are often chosen for their excellent dielectric properties, as well as their ability to maintain structural integrity under the mechanical stresses encountered during cold spraying.

The insulating layer may be applied through techniques such as spray coating, dip coating, or spin coating, depending on the material and the specific geometry of the substrate. For substrates with complex shapes, spray coating is typically preferred, as it allows for even coverage and precise control of the layer thickness. Following application, the insulating layer may undergo curing, which can be performed through thermal processes or exposure to UV light, ensuring that the layer adheres properly and exhibits the desired mechanical and electrical properties.

To improve the mechanical properties or thermal stability of the insulating layer, non-electrically conducting fillers, such as silica, alumina, or mica, may be incorporated into the polymer matrix. These fillers enhance the layer's wear resistance, durability, and thermal performance, making the reflector more robust in harsh environments, such as aerospace or satellite applications where both thermal fluctuations and mechanical stresses are prevalent.

The electrically insulating layer may be applied before the cold spraying of the RF reflective layer, and the thickness of this layer can be adjusted depending on the insulation requirements and mechanical strength needed for the system. Typically, the thickness of the insulating layer may range from a few microns to several hundred microns. The specific thickness will be determined by the balance between the required electrical isolation and the overall design constraints of the reflector, such as weight and flexibility.

Once applied, the insulating layer may undergo inspection and testing, such as dielectric strength tests, visual inspection, thickness measurement, and adhesion testing, or thermal resistance evaluations, to confirm that it meets the necessary performance specifications before proceeding with the cold-sprayed RF reflective layer.

### Application of the Electrostatic Discharge (ESD) White Paint Layer

Following the cold spraying of the RF reflective layer, an electrostatic discharge (ESD) white paint layer may be applied to the outer surface. This top coat may help manage thermal control by reflecting solar energy, radiating energy, and facilitate the dissipation of electrostatic charges that could accumulate on the surface, reducing the risk of potential damage to underlying and adjacent electronic systems.

The ESD white paint layer may include conductive pigments such as metal oxides (e.g., zinc oxide, indium tin oxide), conductive polymers, or carbon-based materials like graphene or carbon black, chosen to achieve the desired level of conductivity and charge dissipation while maintain optical performance for thermal management. The paint layer may be applied using robotic spraying techniques to ensure consistent thickness and even coverage over the surface, allowing it to accommodate various reflector geometries, including parabolic, convex, or other complex shapes.

The thickness of the ESD white paint layer may vary depending on the application, typically ranging from 1 mil to 10 mils (approximately 25 to 250 microns) or more. In some examples, a thickness of 2 to 3 mils (approximately 50 to 75 microns) may be used as an exemplary range, offering coverage for both thermal and electrostatic performance without significantly affecting the RF properties of the underlying cold-sprayed layer.

In addition to providing electrostatic discharge properties, the ESD white paint may contribute to thermal management by offering low solar absorptance (reflecting solar energy) and high emittance (enhancing radiative heat loss). These features may be particularly useful in environments where controlling temperature is important, such as in space-based applications, where reflectors are exposed to varying thermal conditions. By reflecting solar energy and facilitating heat dissipation, the paint layer helps support stable temperature control for the system.

After the paint is applied, it may be air-dried at room temperature or cured at elevated temperatures, depending on the material's requirements. In certain applications, the curing process may involve controlled heating to ensure the paint adheres properly and achieves the intended mechanical and thermal properties.

Once cured, the ESD paint layer may undergo performance assessments, including visual inspection, thickness measurement, and adhesion testing, surface resistivity testing and thermal property evaluations, to verify that it meets the design specifications for electrostatic discharge and thermal performance in the intended operating environment.

### Advantages of the Cold Spray Method

The cold spray method may offer several advantages for manufacturing radio frequency (RF) reflectors, particularly in applications such as aerospace, satellite communication, and other high-performance environments.

One notable advantage is that the cold spray process can operate in ambient conditions, eliminating the need for vacuum chambers. This may simplify the manufacturing environment by allowing the deposition of reflective materials without requiring specialized vacuum systems, potentially streamlining production and reducing equipment overhead. The ambient nature of the cold spray process allows for greater flexibility and can integrate into various production setups without significant additional infrastructure.

Additionally, the cold spray method may enable a reduction in the number of process steps. By depositing the RF reflective material in a single, high-velocity spray, the method can create a mechanically bonded, dense layer without requiring multiple intermediary stages. This streamlined approach may simplify production, reducing the number of touchpoints for quality control while maintaining consistent and reliable results.

The cold spray method may also contribute to shorter production times. The direct deposition of material at high velocity can expedite the formation of the RF reflective layer, especially when coupled with robotic spray systems for both the cold-sprayed layer and the ESD white paint. These combined processes can reduce overall production time, potentially allowing for faster project completion, which is particularly advantageous for industries requiring rapid turnaround times.

From a cost perspective, the cold spray method can be economically beneficial by allowing the process to be scaled efficiently across different production environments. It may reduce operational costs by requiring less specialized equipment and fewer processing steps, making it attractive for larger production runs. Additionally, the lower temperature of the cold spray process may help mitigate the risk of thermal damage to the substrate, reducing the likelihood of material rework and improving cost-efficiency.

The cold spray process may also support environmental efficiency. The method typically requires fewer energy inputs, as it does not involve high-temperature heating or vacuum generation. It is also highly material-efficient, with nearly all sprayed material being deposited onto the substrate, generating minimal waste. This can make the process more sustainable and eco-friendly in the long term.

Another advantage is the enhanced material properties provided by the cold spray method. The high-velocity impact of the particles leads to strong mechanical bonding between the deposited RF reflective layer and the substrate. This can result in a more durable and robust coating that withstands various environmental stresses, such as temperature fluctuations, mechanical forces, or exposure to harsh operating conditions. The flexibility of the cold spray process also allows for thicker layers to be applied when needed, offering additional customization in achieving specific RF performance or structural needs.

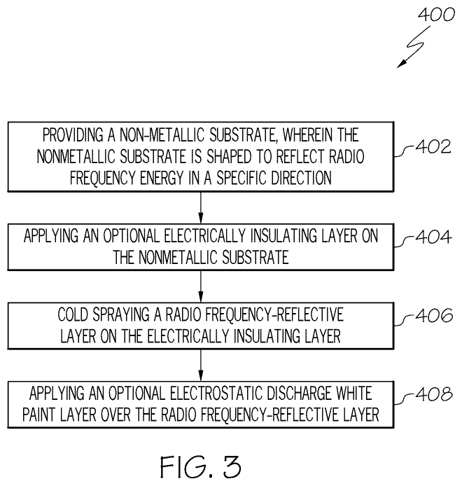

FIG. 3 illustrates an exemplary overall process (400) for manufacturing a radio frequency (RF) reflector using the cold spray method. In the first step (402), a non-metallic substrate is selected and prepared. The substrate may be cleaned and shaped to meet the specific requirements of the RF reflector. In the second step (404), an optional electrically insulating layer may be applied to the substrate. This layer helps prevent electrical interference between the substrate and the cold-sprayed RF reflective layer.

Next, in step (406), the cold-sprayed RF reflective layer is applied to the prepared substrate. This layer may be deposited using a high-velocity cold spray process, resulting in a mechanically bonded reflective surface designed to optimize signal reflectivity and provide durability. Finally, in step (408), an electrostatic discharge (ESD) white paint layer may be applied over the RF reflective layer. This top coat assists with thermal control by reflecting solar energy and dissipating electrostatic charges that may accumulate on the reflector's surface.

### Experimental Results

The experimental evaluation was conducted to assess the performance of the radio frequency (RF) reflector, which comprises a non-metallic substrate and a cold-sprayed radio frequency-reflective layer. The RF reflector was designed for high-performance applications, such as in aerospace or satellite communication systems, where RF reflection, thermal management, and electrostatic discharge (ESD) properties are crucial.

### Experimental Setup and Method

The non-metallic substrate used in these experiments was a graphite-based material, selected for its light weight and excellent thermal conductivity. The substrate was prepared by surface cleaning to ensure proper adhesion for the cold-sprayed RF reflective layer. The substrate was shaped to optimize RF energy reflection, tailored for specific reflector geometries.

A cold-sprayed radio frequency-reflective layer was then applied to the prepared substrate. The cold-spray process was carried out at ambient conditions, using high-velocity aluminum particles. This method resulted in a mechanically bonded layer that enhances RF reflectivity while maintaining the structural integrity of the non-metallic substrate. The thickness of the cold-sprayed RF reflective layer was controlled within a range of 2 mils (approximately 50 microns), which is within the acceptable range for optimizing RF performance in space-based applications.

Following the cold-sprayed layer, an electrostatic discharge (ESD) white paint layer was applied to the RF reflector. The ESD layer, a white silicone-based paint, was applied using robotic spray techniques to ensure uniformity and precise thickness. This layer was designed to provide thermal control by reflecting solar energy and dissipating accumulated electrostatic charges. The thickness of the ESD paint layer ranged between 2 and 3 mils (approximately 50 to 75 microns), providing a balance between thermal management and RF signal performance.

### Optical and Reflective Properties

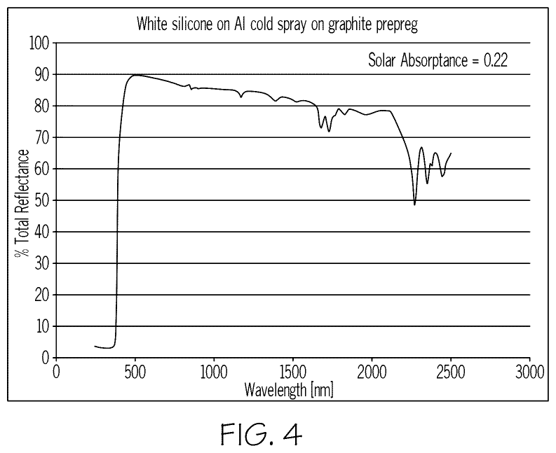

The reflectivity and solar absorptance of the RF reflector were measured to assess the combined effectiveness of the cold-sprayed RF reflective layer and the ESD white paint layer. As shown in FIG. 4, the total reflectance of the reflector across a range of wavelengths demonstrates the high reflectivity of the system. The RF reflector exhibited a solar absorptance of 0.22, indicating its ability to reflect a substantial portion of solar radiation, which is important for thermal management in space applications.

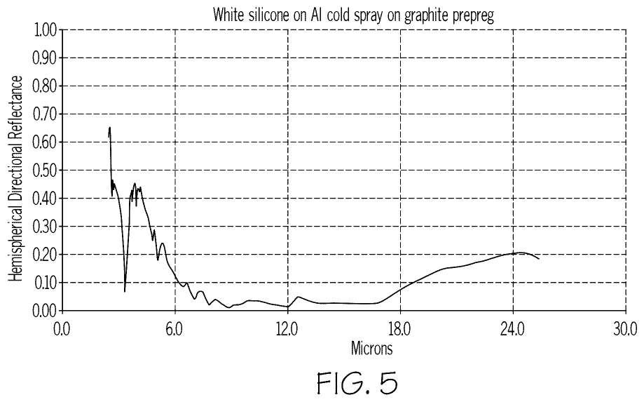

The hemispherical directional reflectance of the RF reflector was analyzed in FIG. 5, using unpolarized light at a 10.0° incident angle and a temperature of 300.0°K (approximately room temperature). The results indicate strong reflective properties across the relevant wavelength range, particularly in the lower spectrum, confirming the cold-sprayed layer's suitability for RF signal reflection. The reflectance in the lower microns demonstrates the material's ability to efficiently reflect RF signals, while the overall reflectance properties also highlight the coating's applicability in thermal management systems. Furthermore, the normal emittance of the RF reflector was calculated to be 0.93, which demonstrates the high radiative heat dissipation of the ESD white paint layer, an important feature for maintaining stable operating temperatures in space environments where thermal regulation is critical.

### Thermal and Electrostatic Performance

The RF reflector was further evaluated for its thermal and electrostatic performance. The ESD white paint layer effectively managed thermal loads by reflecting solar radiation and reducing thermal buildup, making it highly suitable for space-based operations. Additionally, the inclusion of conductive pigments in the ESD paint layer provided efficient electrostatic discharge, preventing the accumulation of charges that could interfere with the system's RF performance.

### Comparison to Heritage Coating Systems

The experimental results highlight the advantages of the cold-spray method and ESD paint layer over traditional multi-layer vapor-deposited coatings. The cold-spray system offers a reduction in process steps significantly simplifying the manufacturing process. The need for vacuum chambers is eliminated, resulting in substantial cost savings.

In terms of performance, the RF reflector demonstrated lower specularity (<0.1%) and improved thermal regulation compared to the heritage multi-layer coatings. The cold-spray method also reduced production times while maintaining high levels of RF reflection and thermal control.

In conclusion, the disclosed radio frequency (RF) reflector and its manufacturing method may provide a range of significant advantages, particularly in high-performance applications such as aerospace and satellite communications. The use of cold-spray technology for the RF reflective layer, combined with the application of an electrostatic discharge (ESD) white paint layer, can simplify the overall production process, making it more efficient and adaptable to various production environments.

One potential benefit is the elimination of the need for vacuum chambers, which may simplify the manufacturing setup and reduce reliance on specialized equipment. This streamlining of the process can lead to shorter production timelines and reduce operational complexity, offering more flexibility in the manufacturing environment. The cold-spray method, conducted at ambient conditions, allows for efficient deposition of the RF reflective layer while preserving the integrity of the non-metallic substrate.

Another advantage may be the reduction in production time. The cold-spray method enables faster deposition of materials, potentially accelerating the overall production cycle. This increased speed could be particularly beneficial in industries where rapid production and deployment are important. Additionally, the cold-spray process allows for precise control of the thickness of both the RF reflective and ESD paint layers, ensuring optimized performance without excessive material usage or added weight.

The cold-spray method may also enhance the durability and performance of the RF reflector. The mechanically bonded structure created through the cold-spray process can result in a robust and reliable RF reflective layer that withstands harsh environmental conditions, including temperature extremes and mechanical stress. The ESD paint layer may further contribute to the reflector's performance by providing effective thermal control and charge dissipation, which are critical in space-based environments where temperature regulation and electrostatic management are essential.

Furthermore, the cold-spray process can be environmentally efficient, with minimal waste generated during production. The method's high material efficiency and reduced energy consumption may make it a more sustainable option compared to traditional techniques, aligning with modern demands for environmentally conscious manufacturing practices.

Overall, the disclosed method offers a combination of potential technical and operational advantages, including increased efficiency, shorter production times, enhanced durability, and environmental benefits. These features make the cold-spray process a valuable approach to the production of RF reflectors, particularly in industries where performance, reliability, and manufacturing efficiency are important considerations.

Although various examples of the disclosed radio frequency reflector, antenna system, and method for manufacturing have been shown and described, modifications may occur to those skilled in the art upon reading the specification. The present application includes such modifications and is limited only by the scope of the claims.

What is claimed is:

1. A radio frequency reflector comprising:
a non-metallic substrate shaped to reflect radio frequency energy in a specific direction; and
a cold-sprayed radio frequency-reflective layer on the non-metallic substrate.

2. The radio frequency reflector of claim 1, wherein the non-metallic substrate is shaped as at least one of a planar surface, parabolic shape, concave shape, convex shape, spherical shape, cylindrical shape, hyperbolic shape, ellipsoidal shape, pyramidal shape, conical shape, truncated cone shape, dish-shaped reflector, waveguide horn shape, corner reflector, compound curve shape, polygonal shape, toroidal shape, or spiral shape.

3. The radio frequency reflector of claim 1, wherein the non-metallic substrate comprises at least one of ceramic, glass, polymer, carbon, and combinations thereof.

4. The radio frequency reflector of claim 1, wherein the non-metallic substrate comprises graphite fibers embedded in a polymer matrix.

5. The radio frequency reflector of claim 1, wherein the cold-sprayed radio frequency-reflective layer comprises at least one metal or alloy selected from the group consisting of aluminum, copper, silver, gold, zinc, magnesium, nickel, platinum, and combinations thereof.

6. The radio frequency reflector of claim 1, wherein the cold-sprayed radio frequency-reflective layer comprises aluminum or an aluminum alloy.

7. The radio frequency reflector of claim 1, wherein the cold-sprayed radio frequency-reflective layer comprises a plurality of cold-sprayed grains, each cold-sprayed grain mechanically bonded to adjacent cold-sprayed grains.

8. The radio frequency reflector of claim 1, wherein the cold-sprayed radio frequency-reflective layer has a thickness in a range of about 1 micron to about 1000 microns.

9. The radio frequency reflector of claim 1, wherein the cold-sprayed radio frequency-reflective layer has a thickness in a range of about 5 microns to about 200 microns.

10. The radio frequency reflector of claim 1, wherein the cold-sprayed radio frequency-reflective layer has a thickness in a range of about 15 microns to about 75 microns.

11. The radio frequency reflector of claim 1, further comprising an electrically insulating layer positioned between the non-metallic substrate and the cold-sprayed radio frequency-reflective layer.

12. The radio frequency reflector of claim 11, wherein the electrically insulating layer comprises one or more of polymers.

13. The radio frequency reflector of claim 1, further comprising an electrostatic discharge paint layer applied on top of the cold-sprayed radio frequency-reflective layer.

14. The radio frequency reflector of claim 13, wherein the electrostatic discharge paint layer comprises a pigment that imparts electrostatic discharge properties and a binder.

15. The radio frequency reflector of claim 14, wherein the pigment comprises at least one of a metal oxide, a mixed metal oxide, a metal-doped oxide, a ceramic particle, and a conductive material.

16. The radio frequency reflector of claim 14, wherein the binder comprises at least one of a organic polymer, a silicate-based binder, an inorganic binder, and a resin.

17. A method for manufacturing a radio frequency reflector, comprising:
providing a non-metallic substrate, wherein the non-metallic substrate is shaped to reflect radio frequency energy in a specific direction; and
cold spraying a radio frequency-reflective layer on the non-metallic substrate.

18. The method of claim 17, further comprising applying an electrically insulating layer on the non-metallic substrate before forming the radio frequency-reflective layer.

19. The method of claim 17, further comprising applying an electrostatic discharge paint layer over the radio frequency-reflective layer.

20. An antenna system comprising:
an antenna for transmitting and a receiving radio frequency energy; and
a radio frequency reflector positioned to direct radio frequency energy towards or away from the antenna,
wherein the radio frequency reflector comprises a non-metallic substrate and a cold-sprayed radio frequency-reflective layer formed on the non-metallic substrate.
